(19) United States
(12) Patent Application Publication
(10) Pub. No.: US 2026/0225068 A1
(43) Pub. Date: Aug. 6, 2026

(54) PROCESSES FOR REDUCING ENVIRONMENTAL AVAILABILITY OF ENVIRONMENTAL POLLUTANTS

(71) Applicant: Albemarle Corporation, Charlotte, NC (US)

(72) Inventors: Kim Sehye PINGREE, Baton Rouge, LA (US); Zhongxin GE, Baton Rouge, LA (US); Zhaorong ZHANG, Baton Rouge, LA (US)

(73) Assignee: Albemarle Corporation, Charlotte, NC (US)

(21) Appl. No.: 19/150,093

(22) PCT Filed: Feb. 14, 2024
(86) PCT No.: PCT/US2024/015760

§ 371 Date: Jul. 22, 2025

Related U.S. Application Data
(60) Provisional application No. 63/447,783, filed on Feb. 23, 2023.

(51) Int. Cl. B01J 20/22; B09C 1/08; C02F 1/28; C02F 101/20; C02F 103/00; C02F 103/06; C02F 103/08

(52) U.S. Cl. CPC B01J 20/22; B09C 1/08; C02F 1/288; C02F 2101/20; C02F 2103/007; C02F 2103/06; C02F 2103/08

(57) ABSTRACT

This invention provides processes for reducing the environmental availability of one or more environmental pollutants in solids, liquids, and combinations of solids and liquids.

### TECHNICAL FIELD

This invention relates to remediation of environmental pollutants to reduce their environmental availability.

### BACKGROUND

Many pollutants are known be toxic to humans and to the environment. One of these known environmental pollutants, mercury, has been categorized as a priority hazardous substance by the Agency for Toxic Substances and Disease Registry (ATSDR) of the U.S. Health and Human Services Department. The U.S. National Priorities List (NPL), maintained by the U.S. Environmental Protection Agency (EPA), has listed numerous sites that were contaminated by mercury, such sites comprising various pollutant-containing substances, including solids (e.g., soil, debris, waste), liquids (e.g., groundwater, lakes, ponds), and combinations of solids and liquids (e.g., sludge, slurries, sediments). The majority of these sites have not been de-contaminated to remove mercury. Unacceptable levels of mercury or mercury compounds may also be present in sites not listed in the U.S. National Priorities List. Environmental pollutants other than mercury raise similar concerns.

Mercury contamination can come from a variety of different sources such as mining and ore processes, metal smelting processes, chlor-alkali plants, mercury-based thermometer and thermostat production processes, fluorescent light production processes, and battery manufacturing processes. There also are many landfills contaminated with mercury-containing waste. Additionally, mercury pollutants are present in multiple forms including elemental mercury, organic mercury compounds, and inorganic mercury compounds, often at the same site. Different mercury forms and/or different substances often require different treating methods.

Mercury contaminated substances are likely to also comprise multiple other environmental pollutants. For example, some substances are also contaminated with organics and/or other heavy elements, and these other environmental pollutants provide similar challenges. Therefore, reducing the environmental availability of environmental pollutants at any particular site can be technically challenging and costly, depending on the substance that is contaminated, condition of the substance, waste types, mercury forms, and other contaminants or environmental pollutants present. Reducing the environmental availability of environmental pollutants, which in turn reduces the bioavailability of pollutants and thus their bioaccumulation, especially in substances such as soils, groundwaters, sediments, and slurries, is of particular interest.

Current commercial remediation processes applied to soils and other solids include stabilization/solidification, washing, thermal desorption, and vitrification. Processes applied to water and other liquids include precipitation/co-precipitation, adsorption, filtration, and bioremediation. Processes applied to sediments and other combinations of solids and liquids include in situ capping, dredging/excavation, a combination of these approaches, as well as Monitored Natural Recovery (MNR) and enhanced Monitored Natural Recovery (EMNR). Monitored natural recovery relies on natural processes to protect the environment and receptors from unacceptable exposures to contaminants, while enhanced MNR applies material or amendments to enhance natural recovery processes (such as the addition of a thin-layer cap or a reactive amendment such as carbon). These remediation technologies all provide benefits in controlling environmental impacts from environmental pollutants, including human health and ecological risks, but these remediation technologies also have limitations.

Another factor to be considered for some remediation technologies is the tendency for an environmental pollutant to migrate from (or leach out of) its location after it has been sequestered or stabilized. The U.S. EPA regulates this as well, and has a Toxicity Characteristic Leaching Procedure (TCLP), a test designed to determine the mobility of both organic and inorganic analytes present in liquid, solid, and multiphasic wastes.

Complicated bench- and pilot-scale research and screening tests have to be conducted to evaluate a technology to determine if it is suitable before it is selected to remediate an actual contaminated site. In addition, the variability with each site to be treated makes the remediation of mercury and other environmental pollutants contamination quite expensive and time-consuming. Thus, there is a need for new and more commercially attractive processes for reducing environmental availability and bioavailability of environmental pollutants in solids and liquids, as well as in combinations thereof.

### SUMMARY OF THE INVENTION

This invention provides processes for reducing environmental availability of at least a portion of one or more environmental pollutants in a substance comprising one or more environmental pollutants. A benefit provided by the processes of this invention is a reduction of environmental availability of toxic environmental pollutants in substances. Such toxic pollutants include mercury and methyl mercury, as well as other heavy elements and ecologically toxic organic matter.

An advantage provided by the processes of this invention is that by reducing environmental availability of environmental pollutants in substances, bioavailability and bioaccumulation of such pollutants is also reduced. When the environmental pollutant is mercury, another advantage is that the processes of the invention do not need sulfide to be present, and so reduction of environmental availability and thus reduction of bioavailability is not negatively affected by acidic conditions which permit sulfides to form hydrosulfide, sulfuric acid, and/or sulfate compounds; this absence of sulfur-containing compounds in turn minimizes mercury methylation.

Processes of this invention can be used as the sole process for reducing the environmental availability and/or the presence of environmental pollutants, such as mercury, in a substance, or can be used to complement and/or enhance the reduction in environmental availability and/or the amount of such environmental pollutants in the substance than is attained by existing technologies.

An embodiment of this invention is a process for reducing environmental availability of at least a portion of one or more environmental pollutants in a substance comprising one or more environmental pollutants. This process comprises adding and/or applying a sorbent comprising one or more N-halogen compounds and one or more substrate materials. The N-halogen compounds contain one or more nitrogen atoms and have one or more halogen atoms bound thereto, and at least one halogen atom bound to a nitrogen atom forms a hypohalite ion when contacted with water. The halogen atoms are selected from chlorine, bromine, and/or iodine, and the N-halogen compound does not contain alkenyl or alkynyl bonds.

These and other embodiments and features of this invention will be still further apparent from the ensuing description and appended claims.

### FURTHER DETAILED DESCRIPTION OF THE INVENTION

The present invention provides processes for reducing the environmental availability of environmental pollutants. As used throughout this document, the term “reducing environmental availability” refers to stabilizing, immobilizing, fixing, encapsulating, isolating, containing, destroying, detoxifying, decomposing, and decaying, reducing the amount of, reducing the mobility of, and/or reducing the migration ability of, at least one environmental pollutant. The stabilizing and/or immobilizing can be in a medium. Reducing the environmental availability of environmental pollutants in turn reduces the bioavailability of pollutants and thus their bioaccumulation.

As used herein, the terms “environmental pollutant” and “environmental pollutants” means a chemical element or compound or mixture thereof known be harmful humans and/or to impact the environment (ecosystem). Environmental pollutants are typically regulated by one or more government agencies. Examples of environmental pollutants include mercury in all of its forms, e.g., elemental mercury (metallic mercury), organic mercury compounds, and inorganic mercury compounds; other organic matter (including, for example, without limitation, hydrophobic organic compounds, polycyclic aromatic hydrocarbons, polyfluoroalkyl substances, perfluoroalkyl substances, polychlorinated biphenyls, dioxins, furans, and/or chlorinated pesticides); hazardous elements, organic and inorganic heavy element compounds (including, for example, without limitation, compounds comprising As, Pb, Zn, Cu, Cr, Ni, and/or Cd); and other environmental pollutants known to those skilled in the art.

As used throughout this document, terms such as “treated”, “contacted”, and “remediated” indicate that the sorbent interacts with the substance containing one or more environmental pollutants in a manner that results in the reduction of environmental availability of one or more environmental pollutants.

The remediation agents in the practice of this invention are sorbents comprising one or more N-halogen compounds and one or more substrate materials. The sorbents comprising one or more N-halogen compounds and one or more substrate materials are sometimes referred to herein as “sorbents”. Sorbents comprising one or more N-halogen compounds and one or more substrate materials are typically formed from one or more N-halogen compounds and one or more substrate materials. Many substrate materials, especially activated carbons, are available or obtainable in a wide range of particle sizes, from nanometer to centimeter.

Substrate materials include carbonaceous materials and inorganic materials. Suitable carbonaceous materials that can be used as sorbents in the practice of this invention include, for example, without limitation, activated carbon, carbon black, char, and coke. A preferred carbonaceous material is activated carbon, which can be used in many forms including, for example, without limitation, powdered, granular, microspherical, pelleted, or extruded; and with high specific surface area.

Another type of substrate material is a carbonaceous material modified by contact with a diatomic halogen (Br₂, Cl₂, BrCl, ICI, IBr, preferably Br₂), which is a halogenated carbonaceous material. Various carbonaceous materials can be modified to form halogenated carbonaceous materials, including activated carbon, carbon black, char, and coke; preferably, the carbonaceous material is activated carbon, and the halogenated carbonaceous materials are halogenated activated carbons. A preferred halogenated carbonaceous material is activated carbon modified by contact with Br₂, a brominated activated carbon.

Suitable inorganic substrate materials include inorganic oxides such as alumina (amorphous, pseudo-crystalline, and crystalline), silica, magnesia and titania; natural zeolites, such as chabazite, clinoptilolite, and faujasite; synthetic zeolites, such as synthetic chabazite, zeolites with high Si:Al ratios (ZSM-5, beta zeolites), zeolites with moderate Si:Al ratios (Y zeolites, A zeolites), silica alumina phosphate (SAPO) zeolites, ion exchanged zeolites, uncalcined zeolites, clay minerals such as kaolin, kaolinite, bentonite, and montmorillonite; synthetic clays such as laponite, saponite, sauconite, stevensite, kaolinite, and hectorite; organo-clays such as montmorillonite that has been treated with a trimethyl stearyl ammonium salt, a dimethyl dialkyl (C₁₄-C₁₈) ammonium salt, a methyl dihydroxy ethyl ammonium salt and a hydrogenated tallow ammonium salt, and aminopropyltriethoxysilane and octadecylamine; bentonite, hectorite, and attapulgite that have been treated with a quaternary ammonium salt; and zeolites that have been treated with a chloride, bromide, and/or hydroxide of N,N,N-trimethyl-1-hexadecanaminium; inorganic hydroxides such as iron hydroxide; mixed metal oxyhydroxide carbonates such as hydrotalcites and metallated double layered clays; diatomaceous earth; cement dust; fluid cracking catalysts, hydroprocessing catalysts including those on substrates such as alumina, silica, or titania; inorganic carbonates, such as alkali metal carbonates (e.g., sodium carbonate and potassium carbonate) and alkaline earth carbonates (e.g., calcium carbonate); and mixtures of any two or more of the foregoing. Preferred inorganic materials include inorganic oxides, especially silica, natural zeolites, especially chabazite, and clay minerals, especially kaolinite and bentonite; CaCO₃ is also a preferred substrate material.

The halogen atoms bound to a nitrogen atom in the N-halogen compound can be chlorine, bromine, iodine, or a mixture of any two or more of these halogens. Bromine and chlorine are preferred halogens; bromine is a more preferred halogen. When more than one halogen atom is present in the N-halogen compound, preferably at least one halogen atom is bromine. When there are two or more nitrogen atoms in the N-halogen compound, more than one nitrogen atom in the N-halogen compound may have one or more halogen atoms bound thereto. There may be more than one halogen atom bound to each nitrogen atom in the N-halogen compound. To be used as an N-halogen compound in the practice of this invention, one halogen atom bound to a nitrogen atom forms a hypohalite ion when contacted with water. Preferably more than one, more preferably all, of the halogen atoms bound to nitrogen atoms in the N-halogen compound form hypohalite ions when contacted with water.

The phrase “contacted by water” indicates that when the N-halogen compound comes into contact with enough water to cause the halogen atom to dissociate from the nitrogen atom to which it is bound, the halogen atom forms the corresponding hypohalite ion. Dissolution of the N-halogen compound is not required for the formation of the hypohalite ion.

Suitable types of compounds include amines, amides, imides, lactams, and hydantoins. Amines include monoamines, diamines, triamines, and other polyamines, which have hydrocarbyl groups that are saturated (straight chain, branched, or cyclic), aromatic, or aromatic-alkyl; for cyclic hydrocarbyl groups, the nitrogen atom can be a ring member. Imides include cyclic compounds, such as succinimide; lactams include pyrrolidone and isocyanuric acid. Hydantoins include 5-hydrocarbyl hydantoins and 5,5-dihydrocarbyl hydantoins. Hydantoins, especially 5,5-dihydrocarbyl hydantoins, are preferred.

In the N-halogen compounds, the hydrocarbyl groups do not contain alkenyl or alkynyl bonds. The saturated groups typically have one to about eight carbon atoms, preferably one to about six carbon atoms; the aromatic groups have six to about fourteen carbon atoms, preferably six to about 10 carbon atoms; and the aromatic-alkyl groups have seven to about fifteen carbon atoms, preferably seven to about eleven carbon atoms. Suitable saturated hydrocarbyl groups include methyl, ethyl, n-propyl, 2-propyl, n-butyl, 2-buytl, tert-butyl, n-pentyl, 3-pentyl, n-hexyl, n-octyl, cyclobutyl, cyclopentyl, 2-methylcyclopentyl, cyclohexyl, and 2-methylcyclohexyl. Suitable aromatic groups include phenyl, 2-methylphenyl, 4-methylphenyl, 4-ethylphenyl, naphthyl, and anthracenyl. Suitable aromatic-alkyl groups include benzyl and xylyl. When the hydrocarbyl group is a ring, the ring may have one or more hydrocarbyl substituents.

N-Halogen compounds that can be used in the practice of this invention include N-bromodimethylamine, N-iododimethylamine, N-chlorodiethylamine, N-bromodiethylamine, N-iododiethylamine, N-chloro-di-n-propylamine, N-bromomethyl-2-propylamine, N-iodo-di-2-propyl amine, N-iodo-di-n-butyl amine, N-chloro-di-2-butylamine, N-bromo-di-tert-butyl amine, N-iodo-di-n-pentylamine, N-chloro-di-3-pentylamine, N-bromo-di-n-hexylamine, N-iodo-di-n-octylamine, N-chloro-di-cyclobutylamine, N-bromo-cyclopentylamine, N-iodo-methyl-2-methylcyclopentylamine, N-chloro-cyclohexylethylamine, N-bromo-2-methylcyclohexylamine, N-iodo-phenylamine, N-chloro-methyl-2-methylphenylamine, N-bromo-4-methylphenylamine, N-iodo-4-ethylphenylmethylamine, N-chloro-naphthylethylamine, N-bromo-anthracenylamine, N-iodo-benzylmethylamine, N-chloro-xylylamine. N-chloro-N-tert-butyl benzamide, N-bromo-N-tert-butyl benzamide, N-iodo-N-tert-butyl benzamide, N-chlorosuccinimide, N-bromosuccinimide, N-iodosuccinimide, N-chloropyrrolidone, N-bromo-pyrrolidone, N-iodopyrrolidone, dichloroisocyanuric acid, dibromoisocyanuric acid, diiodoisocyanuric acid, and the halogen-containing hydantoins described below.

The N-halogen compounds that are halogen-containing hydantoins are halogen-containing 5-hydrocarbyl hydantoins and halogen-containing 5,5-dihydrocarbyl hydantoins which are preferably 1,3-dibromo-, 1,3-dichloro-, and/or N,N′-bromochloro-(or 1,3-bromochloro) derivatives of 5-hydrocarbyl hydantoins and 5,5-dihydrocarbyl hydantoins. Halogen-containing 5,5-dihydrocarbyl hydantoins are preferred. More preferred halogen-containing hydantoins are halogen-containing 5-alkyl and halogen-containing 5,5-dialkyl hydantoins, especially those in which each alkyl group contains up to about 6 carbon atoms. Still more preferred are halogen-containing 5,5-dialkyl hydantoins in which each alkyl group contains, independently, up to 3 carbon atoms. Especially preferred are halogen-containing 5,5-dimethylhydantoins.

Suitable halogen-containing hydantoins include 5-methyl hydantoin, 5-ethyl hydantoin, 5-(1-propyl) hydantoin, 5-(2-propyl) hydantoin, 5-(2-methylpropyl) hydantoin,5-(2-butyl) hydantoin, 5--phenyl hydantoin, 5-ethyl-5-methyl hydantoin, 5-ethyl-5-methyl hydantoin, 5-methyl-5-(2-methylpropyl) hydantoin, 5-ethyl-5-(2-methylpropyl) hydantoin, 5-methyl-5-phenyl hydantoin, 5-ethyl-5-phenyl hydantoin, 5-benzyl-5-methylhydantoin, 5,5-dimethylhydantoin, and 5,5-diethylhydantoin. Preferred halogen-containing hydantoins are 1,3-dihalo-5,5-dimethylhydantoins and 1,3-dihalo-5,5-diethylhydantoins, especially 1,3-dihalo-5,5-dimethylhydantoins. More preferred halogenated hydantoins include 1,3-chloro-5,5-dimethylhydantoin, 1,3-bromochloro-5,5-dimethylhydantoin and 1,3-dibromo-5,5-dimethylhydantoin; still more preferred are 1,3-bromochloro-5,5-dimethylhydantoin and 1,3-dibromo-5,5-dimethylhydantoin, especially 1,3-dibromo-5,5-dimethylhydantoin.

Mixtures of any two or more N-halogen compounds can be used; the N-halogen compounds in the mixtures may contain the same or different halogens, and may be the same or different types of N-halogen compounds.

Particularly preferred N-halogen compounds are halogen-containing amines and halogen-containing hydantoins, especially (bromo) diethylamine, N,N-bromochloro-5,5-dimethylhydantoin and 1,3-dibromo-5,5-dimethylhydantoin, more especially 1,3-dibromo-5,5-dimethylhydantoin.

Sorbents comprising one or more N-halogen compounds and one or more substrate materials can be made from a substrate material and one or more N-halogen compounds. There is usually no need to exclude atmospheric water during preparation of the sorbents comprising one or more N-halogen compounds and one or more substrate materials. In some embodiments, preferred sorbents comprising one or more N-halogen compounds and one or more substrate materials comprise a bromine-containing N-halogen compound as the N-halogen compound. In some embodiments, preferred sorbents comprise activated carbons as the substrate material. In other embodiments, preferred sorbents comprising activated carbons are sorbents comprising chlorine-containing N-halogen compounds and activated carbons, bromine-containing N-halogen compounds and activated carbons, or iodine-containing N-halogen compounds and activated carbons. In preferred embodiments, the sorbents comprising one or more N-halogen compounds and one or more substrate materials are sorbents comprising chlorine-containing N-halogen compounds and activated carbons, or bromine-containing N-halogen compounds and activated carbons. In more preferred embodiments, the sorbents comprising one or more N-halogen compounds and one or more substrate materials are sorbents comprising bromine-containing N-halogen compounds and activated carbons. Even more preferably, the sorbent comprises chlorine-containing 5,5-dihydrocarbyl hydantoins and activated carbons or bromine-containing 5,5-dihydrocarbyl hydantoins and activated carbons, especially 1,3-chloro-5,5-dimethylhydantoin, 1,3-bromochloro-5,5-dimethylhydantoin or 1,3-dibromo-5,5-dimethylhydantoin, still more preferably 1,3-bromochloro-5,5-dimethylhydantoin or 1,3-dibromo-5,5-dimethylhydantoin, especially 1,3-dibromo-5,5-dimethylhydantoin.

In other embodiments, preferred sorbents comprising one or more N-halogen compounds and one or more substrate materials comprise chlorine-containing 5,5-dihydrocarbyl hydantoins and activated carbons or bromine-containing 5,5-dihydrocarbyl hydantoins and activated carbons. More preferably, the N-halogen compounds are halogenated hydantoins, especially 1,3-chloro-5,5-dimethylhydantoin, 1,3-bromochloro-5,5-dimethylhydantoin or 1,3-dibromo-5,5-dimethylhydantoin, still more preferably 1,3-bromochloro-5,5-dimethylhydantoin and/or 1,3-dibromo-5,5-dimethylhydantoin, especially 1,3-dibromo-5,5-dimethylhydantoin.

In other embodiments, preferred sorbents comprising one or more N-halogen compounds and one or more substrate materials comprise chlorine-containing 5,5-dihydrocarbyl hydantoins and one or more halogenated carbonaceous materials; more preferably the halogenated carbonaceous material is a halogenated activated carbon, especially a brominated activated carbon; or bromine-containing 5,5-dihydrocarbyl hydantoins and one or more halogenated carbonaceous materials; more preferably the halogenated carbonaceous material is a halogenated activated carbon, especially a brominated activated carbon. Even more preferably, the sorbent comprises chlorine-containing 5,5-dihydrocarbyl hydantoins and halogenated activated carbons or bromine-containing 5,5-dihydrocarbyl hydantoins and halogenated activated carbons, especially 1,3-chloro-5,5-dimethylhydantoin, 1,3-bromochloro-5,5-dimethylhydantoin or 1,3-dibromo-5,5-dimethylhydantoin, still more preferably 1,3-bromochloro-5,5-dimethylhydantoin or 1,3-dibromo-5,5-dimethylhydantoin, especially 1,3-dibromo-5,5-dimethylhydantoin, especially when the halogenated activated carbon is a brominated activated carbon.

In still other embodiments, preferred sorbents comprise one or more N-halogen compounds and chabazites, one or more N-halogen compounds and bentonites, one or more N-halogen compounds and kaolinites, and one or more N-halogen compounds and silicas; more preferred sorbents comprise chlorine-containing N-halogen compounds and chabazites, bromine-containing N-halogen compounds and chabazites, chlorine-containing N-halogen compounds and bentonites, bromine-containing N-halogen compounds and bentonites, chlorine-containing N-halogen compounds and kaolinites, bromine-containing N-halogen compounds and kaolinites chlorine-containing N-halogen compounds and silicas, and bromine-containing N-halogen compounds and silicas; still more preferred are sorbents comprising bromine-containing N-halogen compounds and silica, bromine-containing N-halogen compounds and kaolinite, and bromine-containing N-halogen compounds and bentonites.

In another embodiment, preferred sorbents include bromine-containing N-halogen compounds and silica, bromine-containing N-halogen compounds and kaolinite, and bromine-containing N-halogen compounds and bentonite. More preferably, the sorbent comprises chlorine-containing 5,5-dihydrocarbyl hydantoins and silica, kaolinite, or bentonite, or bromine-containing 5,5-dihydrocarbyl hydantoins and silica, kaolinite, or bentonite, especially 1,3-chloro-5,5-dimethylhydantoin, 1,3-bromochloro-5,5-dimethylhydantoin or 1,3-dibromo-5,5-dimethylhydantoin, still more preferably 1,3-bromochloro-5,5-dimethylhydantoin or 1,3-dibromo-5,5-dimethylhydantoin, especially 1,3-dibromo-5,5-dimethylhydantoin, especially when the inorganic material is silica, kaolinite, or bentonite.

The amount of halogen (or halogen content) from the N-halogen compound(s) on the sorbent comprising one or more N-halogen compounds and one or more substrate materials is typically equivalent to a total bromine content (or calculated as bromine) in the range of about 0.1 wt % to about 20 wt %, preferably equivalent to a total bromine content in the range of about 0.5 wt % to about 15 wt %, more preferably about 2 wt % to about 12 wt %, and still more preferably about 3 wt % to about 8 wt %, based on the total weight of the sorbent comprising one or more N-halogen compounds and one or more substrate materials.

As used throughout this document, the phrases “as bromine,” “reported as bromine,” “calculated as bromine” and analogous phrases for the halogens refer to the amount of halogen, where the numerical value is calculated for bromine, unless otherwise noted. For example, chlorine may be used, but the amount of halogen in the sorbent comprising one or more N-halogen compounds and one or more substrate materials is stated as the value for bromine.

Sorbents comprising one or more N-halogen compounds and activated carbons suitable for use in processes of this invention can have a wide range of particle sizes and distributions, from nanometer to centimeter; and can be formed from activated carbon forms including, for example, without limitation, powdered, granular, microspherical, pelleted, or extruded; high specific surface area, a variety of unique pore structures; and other features as will be familiar to those skilled in the art.

Sorbents comprising one or more N-halogen compounds and one or more substrate materials, especially sorbents comprising one or more N-halogen compounds and carbonaceous sorbents, especially sorbents comprising one or more chlorine-containing N-halogen compounds and carbonaceous sorbents, or sorbents comprising one or more bromine-containing N-halogen compounds and carbonaceous sorbents, more especially one or more bromine-containing N-halogen compounds and carbonaceous sorbents, can reduce environmental availability of pollutants in substances through means including, for example, without limitation, oxidation and/or adsorption. Adsorption can reduce the environmental availability of environmental pollutants by reducing mobility of such pollutants. Other ways in which sorbents comprising one or more N-halogen compounds and one or more substrate materials can reduce environmental availability of pollutants are by enhancing the degradation of such pollutants through surface reactions; and/or by inhibiting the formation of pollutants such as methyl mercury; and/or by other mechanisms. In the processes of this invention, whether applied to solids, or liquids, or combinations thereof, the environmental pollutants adsorbed by sorbents comprising one or more N-halogen compounds and one or more substrate materials are stabilized such that desorption into the environment is substantially minimized.

Mercury and other environmental pollutants are adsorbed onto or removed by sorbents comprising one or more N-halogen compounds and one or more substrate materials, especially sorbents comprising one or more N-halogen compounds and activated carbons, more especially sorbents comprising one or more chlorine-containing N-halogen compounds and one or more substrate materials, or sorbents comprising one or more bromine-containing N-halogen compounds and one or more substrate materials, more especially bromine-containing N-halogen compounds and carbonaceous sorbents, still more especially bromine-containing N-halogen compounds and activated carbons. Different halogen (especially bromine) species can be formed on sorbents comprising one or more N-halogen compounds and one or more substrate materials, especially sorbents comprising bromine-containing N-halogen compounds and one or more substrate materials, particularly sorbents comprising bromine-containing N-halogen compounds and activated carbons. For example, bromine, a bromine species, can oxidize elemental mercury and form mercuric bromide which can be adsorbed into pores of activated carbon; another species, bromide ion, can chemically bond with ionic mercury for adsorption onto the surface of activated carbon; another component might catalyze mercury oxidation and enhance the stabilization or adsorption of the oxidized mercury product.

Some sorbents comprising one or more N-halogen compounds and one or more substrate materials, particularly sorbents comprising one or more N-halogen compounds and activated carbons, especially sorbents comprising one or more chlorine-containing N-halogen compounds and one or more substrate materials and sorbents comprising one or more bromine-containing N-halogen compounds and one or more substrate materials, more especially sorbents comprising one or more bromine-containing N-halogen compounds and carbonaceous sorbents, particularly sorbents comprising one or more bromine-containing N-halogen compounds and activated carbons, can physically and chemically adsorb mercury of different oxidation states including elemental mercury, oxidized mercury, and organic mercury. Mercury adsorbed on sorbents comprising one or more N-halogen compounds and activated carbon, especially sorbents comprising one or more bromine-containing N-halogen compounds and activated carbon, are stable in a wide range of pH values, where “stable” means that the mercury does not separate from the sorbent in appreciable amounts after adsorption.

The sorbents comprising one or more N-halogen compounds and one or more substrate materials used in processes of this invention can be combined with other optional components such as pH buffers (including, for example, without limitation, ammonium carbonates, metal carbonates, ammonium phosphates, and metal phosphates); carriers (including, for example, without limitation, sand and mud); binders (including, for example, without limitation, mud, clay, and polymers); and/or other additives (including, for example, without limitation, iron compounds and sulfur compounds).

In the practice of this invention, the sorbent comprising one or more N-halogen compounds and one or more substrate materials can be used in various forms, including as dry solids or in combination with a suitable fluid, for example, in a slurry. As used herein, the term “suitable fluid” means fluids such as water, and other fluids. Those skilled in the art, given the teachings of this disclosure, have at hand the knowledge to select a suitable fluid, as the selection depends upon variables such as the composition of the substance, the composition of the environmental pollutants present in the substance, and the like.

Sorbents comprising one or more halogen-containing hydantoins are compositions of this invention, and are formed by processes comprising combining the substrate material and halogen-containing hydantoin(s). Dry blending of the ingredients is a convenient method for combining the ingredients. The substrate materials, halogen-containing hydantoins, amounts thereof, and preferences therefor, are as described above.

Formation of hypohalite ions from the N-halogen compound is part of the treatment of the substance is a feature of this invention. Hypohalite ion formation occurs when the N-halogen compound comes into contact with enough water to cause formation of hypohalite ions. While water is typically present in most substances to be treated, water can be added as part of the treatment when not present in the substance to be treated, or when water is not present in an amount large enough to cause formation of hypohalite ions from the N-halogen compound. When water is added, it can be introduced to the substance in combination with the sorbent comprising one or more N-halogen compounds and one or more substrate materials, or introduced separately from the sorbent comprising one or more N-halogen compounds and one or more substrate materials. When added separately, the water may be added before, during, and/or after the sorbent comprising one or more N-halogen compounds and one or more substrate materials is added and/or applied to the substance.

The amount of water during treatment is generally not important, although preferably the amount of water permits formation of hypohalite ions over time (e.g., about 5 to about 60 minutes) instead of an amount of water that causes all of the hypohalite ion formation to occur soon after application and/or addition to the substance to be treated (e.g., about 5 minutes or less). A preferred amount of water is a soil moisture content of about 100% or an equivalent thereof.

Some treatments of substances can be conducted both in situ and ex situ. Here, “in situ” refers to treatment that occurs without moving the substance from its location. Examples of in situ treatments include injecting the sorbent into the soil (usually as a slurry) or mechanically mixing the sorbent with the soil. Analogously, “ex situ” refers to treatment that occurs during or after removal of the substance from its location; after treatment, the substance may or may not be returned to the location.

Thermal desorption and retorting are two common ex situ methods of thermal treatment for mercury remediation. The technology heats contaminated medium to volatilize mercury, followed by condensing vapors into liquid elemental mercury. A sorbent comprising one or more N-halogen compounds and one or more substrate materials may be used to adsorb mercury as a replacement of the liquid mercury condenser or to remove mercury in off-gasses exiting the condenser.

In some applications, the sorbent will remain in or with the substance. In other applications, the sorbent may be collected after use. When the sorbent is collected after use, the sorbent can be disposed of, or regenerated and re-used.

The substances containing one or more environmental pollutants are solids, liquids, or combinations of a solid and a liquid, or combinations of one or more solids and one or more liquids. When the substance is a solid, it may comprise more than one solid. When the substance is a liquid, it may comprise more than one liquid.

In some processes of this invention, whether applied to a substance comprising one or more solids, one or more liquids, or combinations of at least one solid and at least one liquid, use of the sorbent comprising one or more N-halogen compounds and one or more substrate materials can be a stand-alone remedial approach or can complement the use of other remediation methods. In other processes according to the invention, the sorbent comprising one or more N-halogen compounds and one or more substrate materials can be used in addition to one or more other remediation agents in the same remediation procedure.

Adding a sorbent comprising one or more N-halogen compounds and one or more substrate materials into contaminated waste adsorbs one or more pollutants. In some embodiments, the sorbent comprising one or more N-halogen compounds and one or more substrate materials remains in the substance to stabilize and/or solidify the substance. In other embodiments, the combined sorbent comprising one or more N-halogen compounds and one or more substrate materials and substance are placed in landfill, often with a binder and other compounds.

As used herein, the term “solid” and/or “solids”, include without limitation, soil, debris, waste and other such substances known to those skilled in the art. Soil is a preferred solid to treat in the practice of this invention.

Processes of the invention are provided for reducing environmental availability of at least a portion of one or more environmental pollutants in a solid comprising one or more environmental pollutants. Substances which are solids are sometimes referred to herein as solid substances.

The adding and/or applying of the sorbent comprising one or more N-halogen compounds and one or more substrate materials to the solid can comprise:
(a) injecting the sorbent into the solid, optionally through holes and/or wells and/or channels that are present in the substance, whether already present or manually created, e.g., by drilling into the substance; and/or
(b) applying the sorbent to a surface of the solid; and/or
(c) combining the sorbent with at least a portion of a surface of the solid; and/or
(d) placing the sorbent in a vacuum well in which the solid is treated; and/or
(e) adding the sorbent to a contained solid; and/or
(f) combining the sorbent with the solid; and/or
(g) adding the sorbent to a reactive barrier; and/or
(h) forming a reactive barrier containing the sorbent.

Combining the sorbent comprising one or more N-halogen compounds and one or

more substrate materials with the surface of the solid as in (c) above can be done by combining the sorbent comprising one or more N-halogen compounds and one or more substrate materials with a portion of the solid, and then applying the combination of sorbent and portion of solid to the surface of the solid, or by combining the sorbent with the surface of the solid.

Some preferred methods for adding and/or applying the sorbent comprising one or more N-halogen compounds and one or more substrate materials to the solid are:
(a) injecting a sorbent into the solid;
(b) applying a sorbent to a surface of the solid; and/or
(c) combining a sorbent with at least a portion of a surface of the solid.

An embodiment of treatment of solids to reduce environmental availability of one or more environmental pollutants involves (i) drilling holes, wells, and/or channels into the solid, (ii) covering a surface of the solid with a layer of sorbent comprising one or more N-halogen compounds and one or more substrate materials, and (iii) heating some parts of the solid to migrate one or more environmental pollutants, e.g., mercury, toward the surface which has sorbent comprising one or more N-halogen compounds and one or more substrate materials thereon.

Another embodiment of treatment of solids to reduce environmental availability of one or more environmental pollutants involves (i) drilling holes, wells, and/or channels into the solid, (ii) filling some holes or channels with sorbent comprising one or more N-halogen compounds and one or more substrate materials, and (iii) purging heated air into holes or channels to migrate one or more environmental pollutants, e.g., mercury, toward the holes filled with sorbent comprising one or more N-halogen compounds and one or more substrate materials.

In some embodiments of the invention, the solid is heated to vaporize the environmental pollutant, e.g., mercury, in a vacuum well; when a sorbent comprising one or more N-halogen compounds and one or more substrate materials is present in the vacuum well as in (d) above, the sorbent comprising one or more N-halogen compounds and one or more substrate materials can absorb the vaporized environmental pollutant(s). In these procedures, the sorbent comprising one or more N-halogen compounds and one or more substrate materials is placed in the vacuum well in contact with the vapor produced in the vacuum well at one or more locations before the vapor exits to atmosphere. One application of this procedure is for Soil Vapor Extraction (SVE) for mercury remediation, and sorbents comprising one or more N-halogen compounds and one or more substrate materials, especially sorbents comprising one or more bromine-containing N-halogen compounds and activated carbons, can be placed in the vacuum well to adsorb mercury.

In a particular type of solid substance, soil, sorbents comprising one or more N-halogen compounds and one or more substrate materials can be utilized to immobilize mercury prior to, or during, stabilization and solidification (S/S) of soil in situ and/or ex situ treatment. One ex situ process adds sorbent comprising one or more N-halogen compounds and one or more substrate materials, one or more binders, and other components into a contaminated substance and mixes them together in a reactor. The mixture is then stabilized and cemented or placed in landfill. In some embodiments, sorbents comprising one or more bromine-containing N-halogen compounds and powdered activated carbon can be used in S/S treatment processes. Mercury adsorbed by sorbents comprising one or more bromine-containing N-halogen compounds and powdered activated carbon is stable during making and curing of concrete. This is advantageous because fly ash and cement are typical binders used in S/S technologies.

In another embodiment of this invention in which sorbents comprising one or more N-halogen compounds and one or more substrate materials, especially sorbents comprising one or more bromine-containing N-halogen compounds and powdered activated carbons, are remediation agents for mercury contaminated soil, the sorbent comprising one or more N-halogen compounds and one or more substrate materials is spread on top of the contaminated soil. In this method the soil is not disturbed and the sorbent comprising one or more N-halogen compounds and one or more substrate materials, especially sorbents comprising one or more bromine-containing N-halogen compounds and an activated carbon, is present in the top layer of soil and blocks migration of mercury from the soil.

Sorbents comprising one or more N-halogen compounds and one or more substrate materials, especially sorbents comprising one or more bromine-containing N-halogen compounds and activated carbons containing, can be mixed with another agent to create a mixture that improves penetration of the sorbent comprising one or more N-halogen compounds and one or more substrate materials into the solid, especially soil. The amount of sorbent comprising one or more N-halogen compounds and one or more substrate materials added may be less than 10% of the top layer of soil, and the top layer of soil may be up to 10 cm thick. In some embodiments, a pH adjustment agent is also applied, either separately or in admixture with the sorbent comprising one or more N-halogen compounds and one or more substrate materials, optionally along with an agent that improves penetration of the sorbent into the solid.

Processes of the invention are provided for reducing environmental availability of at least a portion of one or more environmental pollutants in a liquid comprising one or more environmental pollutants. As used herein, the term “liquid” and/or “liquids”, include without limitation, groundwater, wastewater, surface water, salt water, fresh water (e.g., lakes, ponds), and other such substances known to those skilled in the art. Substances which are liquids are sometimes referred to herein as liquid substances.

The adding and/or applying of the sorbent comprising one or more N-halogen compounds and one or more substrate materials to the liquid can comprise:
(a) injecting the sorbent into the liquid; if desired, the used sorbent can be filtered; and/or
(b) applying the sorbent to the surface of the liquid; and/or
(c) combining the sorbent with the liquid; and/or
(d) passing the liquid over a fixed bed comprising the sorbent; and/or
(e) passing the liquid through a filter comprising the sorbent; and/or
(f) pumping the liquid through a fixed bed or column containing the sorbent; and/or
(g) adding the sorbent to a contained volume of liquid.

Combining the sorbent comprising one or more N-halogen compounds and one or more substrate materials with the liquid as in (c) above can be done by combining the sorbent comprising one or more N-halogen compounds and one or more substrate materials with the bulk liquid, or by combining the sorbent comprising one or more N-halogen compounds and one or more substrate materials with a portion of the liquid to form a slurry, and then combining the slurry with the remaining liquid.

Some substances are combinations of at least one solid and at least one liquid, and include sludge, slurries, sediments, pore water (e.g., soil pore water or sediment pore water) and other combinations of solids and liquids. Sediment, soil pore water, and sediment pore water are preferred combination substances to treat in the practice of this invention. These combinations are sometimes referred to as multiphasic substances. Processes of the invention are provided for reducing environmental availability of at least a portion of one or more environmental pollutants in a combination comprising one or more environmental pollutants. Substances which are combinations are sometimes referred to herein as combination substances.

The adding and/or applying of the sorbent comprising one or more N-halogen compounds and one or more substrate materials to the combination can comprise adding and/or applying the sorbent comprising one or more N-halogen compounds and one or more substrate materials to the combination. In such processes, adding and/or applying the sorbent to the combination can comprise:
(a) injecting the sorbent into the combination, optionally through holes and/or wells and/or channels that are present in the substance, whether already present or manually created, e.g., by drilling into the combination; and/or
(b) applying the sorbent to a surface of the combination; and/or
(c) combining the sorbent with at least a portion of a surface of the combination as described above for solid and/or liquid substances; and/or
(d) combining the sorbent with the combination; and/or
(e) placing the sorbent in a vacuum well in which the combination is treated, in a manner similar to that described for solid substances; and/or
(f) adding the sorbent to a contained combination; and/or
(g) covering a surface of the substance with a layer comprising the sorbent, and/or
(h) placing the sorbent into a cap; and/or
(i) adding the sorbent to a reactive barrier; and/or
(j) forming a reactive barrier containing the sorbent; and/or
(k) placing the sorbent within a geotextile mat.

Combining the sorbent comprising one or more N-halogen compounds and one or more substrate materials with the combination as in (d) above can be done by combining the sorbent comprising one or more N-halogen compounds and one or more substrate materials with the combination, or by combining the sorbent comprising one or more N-halogen compounds and one or more substrate materials with a portion of the combination to form a mixture, and then combining the mixture with the surface of the combination. In these embodiments, the sorbent comprising one or more N-halogen compounds and one or more substrate materials can comprise, for example, without limitation, one or more N-halogen compounds and an activated carbon, preferably one or more bromine-containing N-halogen compounds and carbon, more preferably one or more bromine-containing N-halogen compounds and an activated carbon.

Some preferred methods for adding and/or applying the sorbent comprising one or more N-halogen compounds and one or more substrate materials to the combination are:
(a) injecting a sorbent into the combination;
(b) applying a sorbent to a surface of the combination;
(c) combining a sorbent with at least a portion of a surface of the combination; and/or
(d) combining a sorbent with the combination.

As will be clear to those skilled in the art, depending upon the substance treated, numerous variables regarding use of this invention must be considered. In all of the processes of this invention, whether applied to solids, liquids, or combinations thereof, given the teachings herein, those skilled in the art have at hand the knowledge to determine amounts of sorbent comprising one or more N-halogen compounds and one or more substrate materials to use; whether to use optional components in combination with the sorbent, and, if so, the specific optional components and amounts thereof that will be beneficial; the number of applications of processes of this invention, and the period of time between such applications, that will be beneficial; whether to use processes of this invention in combination with known remediation methods, and, if so, how to do so to obtain beneficial results, etc.

The following examples are presented for purposes of illustration, and are not intended to impose limitations on the scope of this invention.

### EXAMPLE 1

Sorbents containing 1,3-dibromodimethylhydantoin (Br₂DMH-PAC) were formed by dry blending 1,3-dibromodimethylhydantoin (Br₂DMH) and powdered activated carbon (PAC) in amounts to achieve a loading of 8 wt % bromine in the Br₂DMH-PAC sorbent.

Samples of soil containing elemental mercury, organic mercury, and other pollutants from a chlor-alkali process was treated with various sorbents by dry mixing each sorbent with a portion of the soil. Each portion was mixed with water, and the water was extracted as the soil leachate; each soil leachate was sampled for analysis. The amount of mercury present in the leachate from the treated soil was determined in an atomic absorption spectrometer with a mercury vapor analyzer via cold vapor atomic absorption (CVAA; Atomic Absorption Mercury Spectrometer with Zeeman background correction, Ohio Lumex Co., model no. RA 915+) according to U.S. EPA method 7473 (Mercury in Solids and Solutions). Results are summarized in Table 1.

TABLE 1

| | Amount | Hg in soil |
|---|---|---|
| Sorbent | sorbent² | leachate, μg/L³ |
| None¹ | 0 | 717 |
| PAC¹ | 5 wt % | 727 |
| Br-PAC^{1,4} (8 wt % Br) | 5 wt % | BD⁶ |
| Br₂DMH-PAC⁵ (8 wt % Br) | 5 wt % | BD⁶ |

¹Comparative example.
²Relative to the weight of soil treated.
³Average of two runs.
⁴Formed from elemental bromine and PAC.
⁵Formed from Br₂DMH and PAC by dry mixing.
⁶BD = below detection limit (1 μg/L).

### Example 2

Natural freshwater sediment was collected from a northern California coastal region, and 100 mg HgCl₂ per kg sediment was added to the natural freshwater sediment. This sediment was incubated at ambient temperature under anaerobic conditions for 4 weeks to generate methylmercury, and then each sample was treated with a sorbent. Porewater was extracted from the sediment by centrifuging a sample of each homogenized sediment at 3,000 relative centrifugal force (RCF or g) for 15 minutes. The amount of methylmercury present in the sediment porewater was determined in an atomic absorption spectrometer with a mercury vapor analyzer via cold vapor atomic absorption (CVAA; Atomic Absorption Mercury Spectrometer with Zeeman background correction, Ohio Lumex Co., model no. RA 915+) according to U.S. EPA method 1630 (Methyl Mercury in Water). Results are summarized in Table 2.

TABLE 2

| | | Amount | Reduction |
|---|---|---|---|
| | Amount | methylHg | relative |
| Sorbent | sorbent² | (ng/L)³ | to control |
| None¹ (control) | 0 | 9.27 | N/A |
| PAC¹ | 1 wt % | 5.70 | 38.5% |
| Br-PAC^{1,4} (8 wt % Br) | 1 wt % | 0.77 | 91.7% |
| Br₂DMH-PAC⁵ (8 wt % Br) | 1 wt % | 0.62 | 93.3% |

¹Comparative example.
²Relative to the weight of sediment treated.
³Average of two runs.
⁴Formed from elemental bromine and PAC.
⁵Formed from Br₂DMH and PAC by dry mixing.

### Example 3

Samples of soil containing mercury were collected from a former munitions site and treated with various sorbents by dry mixing each sorbent with a portion of the soil. Each soil portion was then mixed with enough water to reach 100% moisture content. After a three-day treatment period, each soil portion had water extracted as a soil leachate according to U.S. EPA method 1312. The total mercury in each soil leachate sample was determined by U.S. EPA method 1631, Revision E (Mercury in Water by Oxidation) via cold vapor atomic absorption (CVAA; Atomic Absorption Mercury Spectrometer with Zeeman background correction, Ohio Lumex Co., model no. RA 915+). Results are summarized in Table 3.

TABLE 3

| | | Total Hg in | Reduction |
|---|---|---|---|
| | Amount | leachate after 3 | relative to control |
| Sorbent | sorbent² | days (ng/L)³ | (for total Hg) |
| None¹ (control) | 0 | 97,500 | N/A |
| Br-PAC^{1,4} | 15 wt % | 0.525 | 99.98% |
| (8 wt % Br) | | | |
| Br₂DMH-PAC⁵ | 15 wt % | 0.525 | 99.98% |
| (8 wt % Br) | | | |

¹Comparative example.
²Relative to the weight of sediment treated.
³Average of two runs.
⁴Formed from elemental bromine and PAC.
⁵Formed from Br₂DMH and PAC by dry mixing.

Further embodiments of the invention include, without limitation:
A) A process for reducing environmental availability of at least a portion of one or more environmental pollutants in a substance comprising one or more environmental pollutants, which process comprises
   adding and/or applying a sorbent comprising
      one or more N-halogen compounds containing one or more nitrogen atoms having one or more halogen atoms bound thereto, wherein at least one halogen atom bound to a nitrogen atom forms a hypohalite ion when contacted with water, wherein the halogen atoms are selected from chlorine, bromine, and/or iodine, and wherein the N-halogen compound does not contain alkenyl or alkynyl bonds, and
      one or more substrate materials,
   thereby reducing environmental availability of at least a portion of one or more environmental pollutants in the substance.
B) A process as in A) wherein the sorbent comprises a substrate material selected from
   one or more carbonaceous materials, and optionally wherein the carbonaceous material is activated carbon;
   one or more halogenated carbonaceous materials, and optionally wherein the halogenated carbonaceous material is brominated activated carbon; and/or one or more inorganic materials, and optionally wherein the inorganic material is selected from inorganic oxides, natural zeolites, inorganic carbonates, and clay minerals.
C) A process as in B) wherein the inorganic material is selected from chabazite, silica, kaolinite, and bentonite.
D) A process as in any of A)-C) wherein the halogen atoms of the N-halogen compound comprise bromine atoms and/or chlorine atoms.
E) A process as in A) wherein the sorbent comprises
   an N-halogen compound in which the halogen atoms comprise bromine atoms and an activated carbon substrate material, or
   an N-halogen compound in which the halogen atoms comprise bromine atoms and chlorine atoms and an activated carbon substrate material; or
   an N-halogen compound in which the halogen atoms comprise bromine atoms and a brominated activated carbon substrate material.
F) A process as in any of A)-E) wherein the sorbent has a halogen content of about 0.1 to about 20 wt % from the N-halogen compound, calculated as bromine and based on the total weight of the sorbent.
G) A process as in any of A)-F) wherein the N-halogen compound is a halogen-containing hydantoin.
H) A process as in G) wherein the halogen-containing hydantoin is

1,3-chloro-5,5-dimethylhydantoin, 1,3-bromochloro-5,5-dimethylhydantoin, and/or 1,3-dibromo-5,5-dimethylhydantoin, or
1,3-bromochloro-5,5-dimethylhydantoin and 1,3-dibromo-5,5-dimethylhydantoin.
I) A process as in any of G)-H) wherein the halogen-containing hydantoin is 1,3-dibromo-5,5-dimethylhydantoin.
J) A process as in any of A)-I) wherein the substance comprising said environmental pollutants is a solid, and wherein adding and/or applying the sorbent to the solid comprises:
   (a) injecting a sorbent into the solid;
   (b) applying a sorbent to a surface of the solid;
   (c) combining a sorbent with at least a portion of a surface of the solid;
   (d) placing a sorbent in a vacuum well in which the solid is treated;
   (e) adding a sorbent to a contained solid;
   (f) combining a sorbent with the solid;
   (g) adding a sorbent to a reactive barrier; and/or
   (h) forming a reactive barrier containing sorbent.
K) A process as in J) claim 10 wherein the solid is soil.
L) A process as in any of A)-I) wherein the substance comprising said environmental pollutants is a liquid, and wherein adding and/or applying the sorbent to the liquid comprises:
   (a) injecting a sorbent into the liquid;
   (b) applying a sorbent to the surface of the liquid;
   (c) combining a sorbent with the liquid;
   (d) passing the liquid over a fixed bed comprising a sorbent;
   (e) passing the liquid through a filter comprising a sorbent;
   (f) pumping the liquid through a fixed bed or column containing a sorbent; and/or
   (g) adding a sorbent to a contained volume of liquid.

M) A process as in any of A)-I) wherein the substance comprising said environmental pollutants is a combination of at least one solid and at least one liquid, and wherein adding and/or applying the sorbent to the combination comprises:
(a) injecting a sorbent into the combination;
   (b) applying a sorbent to a surface of the combination; (c) combining a sorbent with at least a portion of a surface of the combination;
   (d) combining the sorbent with the combination;
   (e) placing the sorbent in a vacuum well in which the combination is treated;
   (f) adding the sorbent to a contained combination;
   (g) covering a surface of the substance with a layer comprising a sorbent;
   (h) placing a sorbent into a cap;
   (i) adding a sorbent to a reactive barrier;
   (j) forming a reactive barrier containing a sorbent; and/or
   (k) placing a sorbent within a geotextile mat.
N) A process as in M) wherein the adding and/or applying comprises:
   (a) injecting a sorbent into the solid;
   (b) applying a sorbent to a surface of the solid; and/or
(c) combining a sorbent with at least a portion of a surface of the solid.
O) A process as in M) wherein the combination is sediment, and wherein the adding and/or applying comprises:
   (a) injecting a sorbent into the combination;
   (b) applying a sorbent to a surface of the combination;
   (c) combining a sorbent with at least a portion of a surface of the combination; and/or
   (d) combining a sorbent with the combination.
P) A process as in A) wherein the substance is soil or sediment, and wherein the sorbent comprises an N-halogen compound in which the halogen atoms comprise bromine atoms and an activated carbon substrate material.
Q) A sorbent comprising one or more N-halogen compounds and one or more substrate materials, wherein the N-halogen compound contains one or more nitrogen atoms having one or more halogen atoms bound thereto, wherein at least one halogen atom bound to a nitrogen atom forms a hypohalite ion when contacted with water, wherein the halogen atoms are selected from chlorine, bromine, and/or iodine, and wherein the N-halogen compound does not contain alkenyl or alkynyl bonds.
R) A sorbent as in Q) wherein the sorbent comprises
   a substrate material which is an activated carbon,
   a substrate material which is a halogenated carbonaceous material, optionally wherein the halogenated carbonaceous material is a halogenated activated carbon, and/or
   a substrate material selected from one or more inorganic materials, and optionally wherein the inorganic material is selected from inorganic oxides, natural zeolites, inorganic carbonates, and clay minerals.
S) A sorbent as in Q) or R) wherein the sorbent comprises an N-halogen compound in which the halogen atoms are bromine and/or chlorine.
T) A sorbent as in any of Q)-S) wherein the N-halogen compound is a halogen-containing hydantoin.
U) A sorbent as in T) wherein the halogen-containing hydantoin is
   1,3-chloro-5,5-dimethylhydantoin, 1,3-bromochloro-5,5-dimethylhydantoin, and/or 1,3-dibromo-5,5-dimethylhydantoin, or
   1,3-bromochloro-5,5-dimethylhydantoin and 1,3-dibromo-5,5-dimethylhydantoin.
V) A sorbent as in any of T)-U) wherein the halogen-containing hydantoin is 1,3-dibromo-5,5-dimethylhydantoin.
W) A sorbent as in any of R)-V) wherein the sorbent has a halogen content of about 0.1 to about 20 wt % from the N-halogen compound, calculated as bromine and based on the total weight of the sorbent.
X) A process for forming a sorbent, which process comprises combining one or more N-halogen compounds and one or more substrate materials, wherein the N-halogen compound contains one or more nitrogen atoms having one or more halogen atoms bound thereto, wherein at least one halogen atom bound to a nitrogen atom forms a hypohalite ion when contacted with water, wherein the halogen atoms are selected from chlorine, bromine, and/or iodine, and wherein the N-halogen compound does not contain alkenyl or alkynyl bonds, to form the sorbent.
Y) A process as in X) wherein the sorbent comprises
   a substrate material which is an activated carbon,
   a substrate material which is a halogenated carbonaceous material, optionally wherein the halogenated carbonaceous material is a halogenated activated carbon, and/or
   a substrate material selected from one or more inorganic materials, and optionally wherein the inorganic material is selected from inorganic oxides, natural zeolites, inorganic carbonates, and clay minerals.
Z) A process as in X) or Y) wherein the N-halogen compound comprises halogen atoms which are bromine and/or chlorine.
AA) A process as in any of X)-Z) wherein the N-halogen compound is a halogen-containing hydantoin.
AB) A process as in AA) wherein the halogen-containing hydantoin is
   1,3-chloro-5,5-dimethylhydantoin, 1,3-bromochloro-5,5-dimethylhydantoin, and/or 1,3-dibromo-5,5-dimethylhydantoin, or
   1,3-bromochloro-5,5-dimethylhydantoin and/or 1,3-dibromo-5,5-dimethylhydantoin.
AC) A process as in any of AA)-AB) wherein the halogen-containing hydantoin is 1,3-dibromo-5,5-dimethylhydantoin.
AD) A process as in any of X)-AD) wherein the sorbent has a halogen content of about 0.1 to about 20 wt % from the N-halogen compound, calculated as bromine and based on the total weight of the sorbent.
AE) A sorbent comprising one or more halogen-containing hydantoins and one or more substrate materials, wherein the halogen-containing hydantoin comprises one or more halogen atom bound to one or more nitrogen atoms, wherein the halogen atoms are selected from chlorine, bromine, and/or iodine.
AF) A sorbent as in AE) wherein the substrate material is selected from one or more carbonaceous materials, one or more halogenated carbonaceous materials, and/or from one or more inorganic materials.
AG) A sorbent as in AF) wherein the carbonaceous material is activated carbon, the halogenated carbonaceous material is halogenated activated carbon, and wherein the inorganic material is selected from inorganic oxides, natural zeolites, inorganic carbonates, and clay minerals.
AH) A sorbent as in any of AE)-AG) wherein the halogen-containing hydantoin is 1,3-chloro-5,5-dimethylhydantoin, 1,3-bromochloro-5,5-dimethylhydantoin, and/or 1,3-dibromo-5,5-dimethylhydantoin.
AI) A sorbent as in AH) wherein the halogen-containing hydantoin is 1,3-dibromo-5,5-dimethylhydantoin.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process for reducing environmental availability of at least a portion of one or more environmental pollutants in a substance comprising one or more environmental pollutants, which process comprises
adding and/or applying a sorbent comprising
one or more N-halogen compounds containing one or more nitrogen atoms having one or more halogen atoms bound thereto, wherein at least one halogen atom bound to a nitrogen atom forms a hypohalite ion when contacted with water, wherein the halogen atoms are selected from chlorine, bromine, and/or iodine, and wherein the N-halogen compound does not contain alkenyl or alkynyl bonds, and
one or more substrate materials,
thereby reducing environmental availability of at least a portion of one or more environmental pollutants in the substance.

2. A process according to claim 1 wherein the sorbent comprises a substrate material selected from one or more carbonaceous materials, and optionally wherein the carbonaceous material is activated carbon;
one or more halogenated carbonaceous materials, and optionally wherein the halogenated carbonaceous material is brominated activated carbon; and/or
one or more inorganic materials, and optionally wherein the inorganic material is selected from inorganic oxides, natural zeolites, inorganic carbonates, and clay minerals.

3. A process according to claim 2 wherein the inorganic material is selected from chabazite, silica, kaolinite, and bentonite.

4. A process according to claim 1 wherein the halogen atoms of the N-halogen compound comprise bromine atoms and/or chlorine atoms.

5. A process according to claim 1 wherein the sorbent comprises
an N-halogen compound in which the halogen atoms comprise bromine atoms and an activated carbon substrate material, or
an N-halogen compound in which the halogen atoms comprise bromine atoms and chlorine atoms and an activated carbon substrate material; or
an N-halogen compound in which the halogen atoms comprise bromine atoms and a brominated activated carbon substrate material.

6. A process according to claim 1 wherein the sorbent has a halogen content of about 0.1 to about 20 wt % from the N-halogen compound, calculated as bromine and based on the total weight of the sorbent.

7. A process according to claim 1 wherein the N-halogen compound is a halogen-containing hydantoin.

8. A process according to claim 7 wherein the halogen-containing hydantoin is
1,3-chloro-5,5-dimethylhydantoin, 1,3-bromochloro-5,5-dimethylhydantoin, and/or 1,3-dibromo-5,5-dimethylhydantoin, or
1,3-bromochloro-5,5-dimethylhydantoin and 1,3-dibromo-5,5-dimethylhydantoin.

9. A process according to claim 7 wherein the halogen-containing hydantoin is 1,3-dibromo-5,5-dimethylhydantoin.

10. A process according to claim 1 wherein the substance comprising said environmental pollutants is a solid, and wherein adding and/or applying the sorbent to the solid comprises:
(a) injecting a sorbent into the solid;
(b) applying a sorbent to a surface of the solid;
(c) combining a sorbent with at least a portion of a surface of the solid;
(d) placing a sorbent in a vacuum well in which the solid is treated;
(e) adding a sorbent to a contained solid;
(f) combining a sorbent with the solid;
(g) adding a sorbent to a reactive barrier; and/or
(h) forming a reactive barrier containing sorbent.

11. A process according to claim 10 wherein the solid is soil.

12. A process according to claim 1 wherein the substance comprising said environmental pollutants is a liquid, and wherein adding and/or applying the sorbent to the liquid comprises:
(a) injecting a sorbent into the liquid;
(b) applying a sorbent to the surface of the liquid;
(c) combining a sorbent with the liquid;
(d) passing the liquid over a fixed bed comprising a sorbent;
(e) passing the liquid through a filter comprising a sorbent;
(f) pumping the liquid through a fixed bed or column containing a sorbent; and/or
(g) adding a sorbent to a contained volume of liquid.

13. A process according to claim 1 wherein the substance comprising said environmental pollutants is a combination of at least one solid and at least one liquid, and wherein adding and/or applying the sorbent to the combination comprises:
(a) injecting a sorbent into the combination;
(b) applying a sorbent to a surface of the combination; (c) combining a sorbent with at least a portion of a surface of the combination;
(d) combining the sorbent with the combination;
(e) placing the sorbent in a vacuum well in which the combination is treated;
(f) adding the sorbent to a contained combination;
(g) covering a surface of the substance with a layer comprising a sorbent;
(h) placing a sorbent into a cap;
(i) adding a sorbent to a reactive barrier;
(j) forming a reactive barrier containing a sorbent; and/or
(k) placing a sorbent within a geotextile mat.

14. A process according to claim 13 wherein the adding and/or applying comprises:
(a) injecting a sorbent into the solid;
(b) applying a sorbent to a surface of the solid; and/or
(c) combining a sorbent with at least a portion of a surface of the solid.

15. A process according to claim 13 wherein the combination is sediment, and wherein the adding and/or applying comprises:
(a) injecting a sorbent into the combination;
(b) applying a sorbent to a surface of the combination;
(c) combining a sorbent with at least a portion of a surface of the combination; and/or
(d) combining a sorbent with the combination.

16. A process according to claim 1 wherein the substance is soil or sediment, and wherein the sorbent comprises an N-halogen compound in which the halogen atoms comprise bromine atoms and an activated carbon substrate material.

17. A sorbent comprising one or more N-halogen compounds and one or more substrate materials, wherein the N-halogen compound contains one or more nitrogen atoms having one or more halogen atoms bound thereto, wherein at least one halogen atom bound to a nitrogen atom forms a hypohalite ion when contacted with water, wherein the halogen atoms are selected from chlorine, bromine, and/or iodine, and wherein the N-halogen compound does not contain alkenyl or alkynyl bonds.

18. A sorbent as in claim 17 wherein the sorbent comprises
a substrate material which is an activated carbon,
a substrate material which is a halogenated carbonaceous material, optionally wherein the halogenated carbonaceous material is a halogenated activated carbon, and/or
a substrate material selected from one or more inorganic materials, and optionally wherein the inorganic material is selected from inorganic oxides, natural zeolites, inorganic carbonates, and clay minerals.

19. A sorbent as in claim 17 wherein the sorbent comprises an N-halogen compound in which the halogen atoms are bromine and/or chlorine.

20. A sorbent as in claim 17 wherein the N-halogen compound is a halogen-containing hydantoin.

21. A sorbent as in claim 20 wherein the halogen-containing hydantoin is 1,3-chloro-5,5-dimethylhydantoin, 1,3-bromochloro-5,5-dimethylhydantoin, and/or 1,3-dibromo-5,5-dimethylhydantoin, or 1,3-bromochloro-5,5-dimethylhydantoin and 1,3-dibromo-5,5-dimethylhydantoin.

22. A sorbent as in claim 20 wherein the halogen-containing hydantoin is 1,3-dibromo-5,5-dimethylhydantoin.

23. A sorbent as in claim 18 wherein the sorbent has a halogen content of about 0.1 to about 20 wt % from the N-halogen compound, calculated as bromine and based on the total weight of the sorbent.

24. A process for forming a sorbent, which process comprises combining one or more N-halogen compounds and one or more substrate materials, wherein the N-halogen compound contains one or more nitrogen atoms having one or more halogen atoms bound thereto, wherein at least one halogen atom bound to a nitrogen atom forms a hypohalite ion when contacted with water, wherein the halogen atoms are selected from chlorine, bromine, and/or iodine, and wherein the N-halogen compound does not contain alkenyl or alkynyl bonds, to form the sorbent.

25. A process as in claim 24 wherein the sorbent comprises
a substrate material which is an activated carbon,
a substrate material which is a halogenated carbonaceous material, optionally wherein the halogenated carbonaceous material is a halogenated activated carbon, and/or
a substrate material selected from one or more inorganic materials, and optionally wherein the inorganic material is selected from inorganic oxides, natural zeolites, inorganic carbonates, and clay minerals.

26. A process as in claim 24 wherein the N-halogen compound comprises halogen atoms which are bromine and/or chlorine.

27. A process as in claim 24 wherein the N-halogen compound is a halogen-containing hydantoin.

28. A process as in claim 27 wherein the halogen-containing hydantoin is
1,3-chloro-5,5-dimethylhydantoin, 1,3-bromochloro-5,5-dimethylhydantoin, and/or 1,3-dibromo-5,5-dimethylhydantoin, or
1,3-bromochloro-5,5-dimethylhydantoin and/or 1,3-dibromo-5,5-dimethylhydantoin.

29. A process as claim 27 wherein the halogen-containing hydantoin is 1,3-dibromo-5,5-dimethylhydantoin.

30. A process as in claim 24 wherein the sorbent has a halogen content of about 0.1 to about 20 wt % from the N-halogen compound, calculated as bromine and based on the total weight of the sorbent.

31. A sorbent comprising one or more halogen-containing hydantoins and one or more substrate materials, wherein the halogen-containing hydantoin comprises one or more halogen atom bound to one or more nitrogen atoms, wherein the halogen atoms are selected from chlorine, bromine, and/or iodine.

32. A sorbent as in claim 31 wherein the substrate material is selected from one or more carbonaceous materials, one or more halogenated carbonaceous materials, and/or from one or more inorganic materials.

33. A sorbent as in claim 32 wherein the carbonaceous material is activated carbon, the halogenated carbonaceous material is halogenated activated carbon, and wherein the inorganic material is selected from inorganic oxides, natural zeolites, inorganic carbonates, and clay minerals.

34. A sorbent as in claim 31 wherein the halogen-containing hydantoin is 1,3-chloro-5,5-dimethylhydantoin, 1,3-bromochloro-5,5-dimethylhydantoin, and/or 1,3-dibromo-5,5-dimethylhydantoin.

35. A sorbent as in claim 34 wherein the halogen-containing hydantoin is 1,3-dibromo-5,5-dimethylhydantoin.
